(19) United States
(12) Patent Application Publication
(10) Pub. No.: US 2024/0308096 A1
(43) Pub. Date: Sep. 19, 2024

(54) CUTTING APPARATUS FOR CUTTING SEGMENTS FOR ENERGY CELLS FROM A FED CONTINUOUS WEB

(71) Applicant: KÖRBER TECHNOLOGIES GMBH, Hamburg (DE)

(72) Inventors: Manfred FOLGER, Hamburg (DE); Marcus WAGNER, Hamburg (DE); Nils KLAPER, Drage (DE)

(21) Appl. No.: 18/573,675

(22) PCT Filed: Jul. 7, 2022
(86) PCT No.: PCT/EP2022/068879

§ 371 Date: Dec. 22, 2023

(30) Foreign Application Priority Data
Jul. 12, 2021 (DE) 10 2021 207 343.3

(51) Int. Cl. B26D 1/40; B26D 1/00; B26D 7/10; B26D 7/18

(52) U.S. Cl. CPC B26D 1/405; B26D 1/0006; B26D 7/10; B26D 7/1863; B26D 2001/006

(57) ABSTRACT

Cutting apparatus for cutting segments for energy cells from a continuous web fed into an intermediate space in a cutting plane, having a cutting rotating device which is driven in rotary movement around a rotational axis by the means of a driving device, is arranged on one side of the intermediate space and has at least one cutting blade projecting radially outwards from an interface of the cutting rotating device and at least one counter blade arranged on the other side of the intermediate space, wherein the cutting blade and the counter blade each have a cutting edge, characterised in that the cutting blade comes to rest with its cutting edge in a point-like contact on the cutting edge of the counter blade during the rotary movement of the cutting rotating device, and is thereby aligned at an angle of not equal to zero degrees in relation to the cutting edge of the counter blade, wherein the cutting edge of the cutting blade slides on the cutting edge of the counter blade during the rotary movement of the cutting rotating device with a cut being made in the continuous web during the point-like contact.

The present invention concerns a cutting apparatus for cutting segments for energy cells from a fed continuous web with the features of the preamble of claim 1.

Energy cells or also energy stores in the meaning of the invention are used e.g. in motor vehicles, other land vehicles, ships, aircraft, or also in stationary systems, such as photovoltaic systems in the form of battery cells or fuel cells, in which very large energy quantities have to be stored over relatively long time periods. For this purpose, such energy cells have a structure composed of a plurality of segments stacked to form a stack. These segments are each formed from alternate anode sheets and cathode sheets which are similarly separated from each other by segments produced as separator sheets. The segments are precut in the production process and then placed on top of each other to form the stacks in the predetermined order and connected by lamination with each other. The anode sheets and cathode sheets are initially cut from a continuous web and then each separately placed at intervals on a continuous web of a separator material. This subsequently formed “two-layered” continuous web made from the separator material with the placed anode sheets or cathode sheets is then cut again in a second step with a cutting apparatus, wherein the segments in this case are formed in two layers by a separator sheet with an anode sheet and cathode sheet arranged on top. If this is doable or required from a manufacturing point of view, the continuous webs of the separator material with the placed anode webs and cathode webs can also be placed on each other before the cutting, so that a continuous web is formed having a first endless layer of the separator material with anode sheets or cathode sheets placed on it and a second endless layer of the separator material with anode sheets or cathode sheets placed on it again. This “four-layer” continuous web is then cut by means of a cutting apparatus into segments which in this case are formed in four layers having a first separator sheet, an anode sheet, a second separator sheet and a cathode sheet placed on top. The advantage of this solution is that a cut can be saved. Segments in the meaning of this invention are single-layer segments of a separator material, anode material or cathode material, two-layer or also four-layer segments of the above-described construction.

The production of battery cells, for example for electromobility, occurs currently in production systems which produce 100 to 240 monocells per minute. These work in stages or continuously with timed discontinuous movements, such as back and forth movements, and thus the production performance is limited. A large proportion of the known machines work in a single-sheet stacking process (e.g. pick and place) with the disadvantage of slower processing. The lamination of cell formations is not possible here.

A further known approach is a machine with continually running material webs and timed tools, such as for example separating blades, tools for pitch changing.

In principle, machines having timed movements are performance restricted. The parts which are subjected to mass, for instance receptacles and tools, must be permanently accelerated and braked. The processes determine the time sequences and thus a lot of energy is used. The mass of the moving parts cannot be arbitrarily reduced. Frequently, faster moving parts must endure higher loads and thus are even more complex and heavier.

In order to reduce the production costs of battery production, among other things the production performance of the machine must be increased. A condition for high production performance is a high production rate of the energy cell stacks which consist of a plurality of segments stacked on each other of the type described above.

To achieve very high production rates, it is desirable to continually feed the continuous webs made from the material of the segments and then to cut off the segments from these continually fed continuous webs by means of a cutting apparatus in the ongoing process. This is the case in particular with the anode sheets and cathode sheets which are cut and subsequently placed at intervals on a continuous web of a separator material.

Such an apparatus for producing energy cells with a cutting apparatus is known for example from DE 10 2017 216 213 A1. The cutting apparatus is realised here in the form of a laser cutting apparatus which has a laser which is directed on the periphery of a drum and cuts the segments from a continuous web fed on the drum. The disadvantage with this cutting device is that the cutting process requires very exact control of the laser. If the laser beam cannot directly be directed onto the continuous web to be cut, this is deflected by a scanner fixed in relation to the continuous web (remote laser cutting). The scanner comprises among others a mirror and assigned motors which, on the basis of their restricted dynamics, impose limits on the speed of the cutting process.

Furthermore, an apparatus is known from document U.S. Pat. No. 6,585,846 B1 in which the segments are cut from a continuous web by means of a cutting drum driven in rotary movement and having one or more cutting blades and a counter drum having one or more counter blades. The cutting drum and the counter drum are driven in opposite directions of rotation with identical speeds, such that they have an identical peripheral speed in the same direction in the mutually opposite sections of the lateral surfaces in relation to the movement of the fed continuous web. The cutting edges of the cutting blades and the counter blades are arranged parallel to the rotational axes of the cutting drum and the counter drum and perpendicular to the orbital movements and effect a perpendicular linear cut through the continuous web running through between the cutting drum and counter drum for cutting the segments.

The disadvantage with this solution, however, is that the rotary movements of the cutting drum and the counter drum have to be coordinated to each other very exactly, and that in particular differences in rotational speed in any case must in particular be avoided as otherwise a clean cut through the continuous web cannot be achieved. Furthermore, the cutting edges of the cutting blades and the counter blades here cut through the continuous web with their entire length simultaneously, which requires correspondingly high cutting forces. Therefore, the cutting width to be achieved is restricted, and increased wear of the cutting edges occurs in connection with a deteriorated cut quality.

Furthermore, an apparatus is known from publication WO 2019/092585 A2 which has two cutting drums driven in opposite directions of rotation, each with a cutting blade. The cutting drums are arranged so that the cutting circles, defined by the cutting edges of the cutting blades, of the cutting edges do not overlap, wherein the interval between the cutting circles should be 1 to 10 μm. The rotary drive movements of both cutting drums are so coordinated to each other that the cutting blades cut simultaneously but at the predetermined interval of 1 to 10 μm in relation to each other through the continuous web. The cutting edges of the cutting blades are also aligned parallel to the rotational axes of the cutting drums and thus parallel to each other, such that the cutting edges each cut through the continuous web over the entire width in a linear cut.

The disadvantage of this solution is that, here too, the rotary movements of the cutting drums must be coordinated very precisely with each other, so that the two cutting edges cut through the continuous web in a defined alignment in relation to each other to achieve a clean cut. Along with the above-described disadvantages of the high cutting forces, the restricted cutting width, the increased wear and deterioration of the cut quality, additionally this apparatus requires very exact positioning of the cutting drums and the cutting edges revolving around them, so that the required interval is not undercut, as otherwise the cutting edges could collide. Furthermore, the interval of the cutting circles cannot be larger than the specified interval of 1 to 10 μm, as otherwise a clean cut cannot be achieved because the cutting edges each form the abutment required for the cut against each other.

In this context the object of the invention is to provide a cutting apparatus which enables a clean, process-reliable cutting of segments for energy cells from a continuous web with a similarly high transport speed of the fed continuous web.

A cutting apparatus having the features of claim 1 is proposed to solve the object. Further preferred developments of the invention can be found in the sub-claims, the description and the related figures.

According to the fundamental idea of the invention, it is proposed that the cutting edge of the cutting blade comes into point-like contact with the cutting edge of the counter blade during the rotary movement of the cutting rotating device, in particular of the cutting drum, and is thereby aligned at an angle not equal to zero degrees to the cutting edge of the counter blade, wherein the cutting edge of the cutting blade slides on the cutting edge of the counter blade during the rotary movement of the cutting rotating device, in particular the cutting drum, with a cut being made in the continuous web during the point-like contact.

The invention thus takes a fundamentally different approach to cutting the segments from the continuous web compared to the solutions known in the prior art, in that the cutting blade deliberately comes to rest with its cutting edge against the cutting edge of the counter blade, so that the continuous web fed in between is reliably severed. Furthermore, the cutting edges are aligned in relation to each other so that they are aligned in the point-like contact in relation to each other at an angle not equal to zero degrees, so that the cutting blade during the rotary movement of the cutting rotating device, in particular the cutting drum, slides in point-like contact on the cutting edge of the counter blade and thus cuts through the continuous web. The continuous web is thus not cut over its entire width simultaneously during the cutting process, but instead in a point-like contact which performs a movement in the longitudinal direction of the cutting edges during the cutting process and thus severs the continuous web in a continual cut transverse to its longitudinal extension. Thus, a cut can be made with significantly lower cutting forces at a simultaneously unrestricted or at least significantly larger width of the continuous web to be cut. Thus, the point-like contact point moves on a curved track which results from the combination of the movement of the contact point transverse to the continuous web along the cutting edge of the counter blade with the rotary movement of the counter blade executed in the process, i.e. a circular arc movement. The movement of the contact point is achieved by the alignment of the cutting edges at an angle not equal to zero degrees, in connection with the rotary movement of the cutting rotating device, in particular the cutting drum, i.e. the movement of the cutting edges relative to each other. This cutting process, which differs fundamentally from the state of the art, enables the continuous web to be cut in a way that is particularly gentle on the surface with very little surface contamination.

The counter blade need not be formed by a separate part, it can also be integrated in one piece in the form of a corresponding design of the counter rotation body, in particular the counter drum. Furthermore, the counter blade can also be a part of an insert portion which is mounted on the periphery of the counter rotation body, in particular of the counter drum, and can have additional functions. All that is importantly for the realization of the counter blade is that a cutting edge is formed in the form of a sharp edge on the counter rotation body, in particular the counter drum, on which the cutting blade of the cutting rotating device, in particular the cutting drum, slides with its cutting edge. The counter blade in the sense of the invention is thus to be understood as the section of the counter rotation body, in particular of the counter drum, on which the cutting edge is provided, irrespective of whether the counter blade is realised as a separate insert part or is formed as one piece with the counter rotation body, in particular the counter drum.

Furthermore, the feature of the point-like contact should not be understood in the purely mathematical sense. Rather, it should be used to express the fact that the cutting blade and the counter blade are only placed on each other in a very short section during the cutting process, which for example is increased in size to a somewhat longer section by virtue of the elastic characteristics of the cutting blade and/or the counter blade alone. It is merely important for the cutting process that the cutting blade and the counter blade are placed on each other in this short section and that the cutting blade and the counter blade slide on each other during the cutting process by executing a longitudinal movement of this contact point and thereby cut the continuous web transversely to its longitudinal extension by a shearing process.

It is further proposed that the angle between the cutting edge is at most 20 degrees. Due to the proposed angle range, the occurring cutting power can be clearly reduced in comparison to a solution with parallel cutting edges, so that a particularly clean cut of the segments can be achieved, and the blade deterioration can be reduced.

Furthermore, it is proposed that the cutting edges are aligned in relation to each other in a cutting plane running through the point-like contact at a first angle not equal to zero degrees. Due to the proposed alignment, along with the above-described advantageous cutting process, the transport movement of the continuous web can additionally be compensated to the extent that, in the ideal case, a perpendicular cut can be realised through the continuous web during the transport movement. This cutting plane is the plane which is arranged tangentially to the lateral surface of the counter rotation body, in particular the counter drum, and is arranged in the point-like contact. Since the cutting edges slide on each other in the point-like contact, the location of the cutting plane also changes. If straight cutting blades and counter blades are used, this change does not have an effect on the first angle however, as the first angle is always the same independent of the location of the contact point owing to the straight cutting edge. If curved cutting edges were to be used, the first angle would change during the cutting process and the sliding of the cutting edges, however it should never be equal to zero, as otherwise the shearing effect necessary for the cutting is not there anymore. The point-like contact is not understood in a mathematical sense here either. It should therefore only be understood to express the fact that the cutting edges only lie on each other over a very short section which is ideally point-like. Since the cutting blade and the counter blade always yield only marginally owing to their resilient characteristics, the point-like contact is always increased in size to a somewhat longer contact by the cutting edges of the cutting blade and the counter blade lying on each other.

Furthermore, it is proposed that the cutting edges are aligned perpendicular to the cutting plane at a second angle not equal to zero degrees. Due to the proposed design and alignment of the cutting edges, the rotary movement of the cutting rotating device, in particular of the cutting drum, and the movement of the cutting edge caused thereby can be compensated perpendicular to the cutting plane, at least insofar as the cutting edges, despite a movement perpendicular to the cutting plane, do not lose the point-like contact.

Furthermore, it is proposed that the cutting blade and/or counter blade are resiliently mounted. As described above, the cutting of the continuous web results in a point-like contact of the cutting edges. So that the contact is never lost, the cutting edges and cutting circles thereof are dimensioned and arranged such that they at least marginally overlap in the cutting plane. This overlap leads to an excess pressure on the cutting edges so that they exert a certain pressure force on each other during the cutting of the continuous web. This excess pressure can lead to a blade breakage or damage of the cutting edge in extreme cases. To reduce this pressure force again and thus the associated probability of damage of the cutting edges, the cutting blade and/or counter blade are resiliently mounted so that the contact pressure of the cutting edges is reduced by the cutting edges being able to yield marginally.

Alternatively, or additionally, it is proposed that the cutting edge of the cutting blade and/or the cutting edge of the counter blade has a concave shape. It has been found that even in the case of straight cutting edges, the excess pressure increases from zero or a very low value to a maximum during the cutting process and the movement of the contact point along the cutting edges, and then falls again. Due to the concave design of the cutting edges, this effect can at least partially be compensated and the excess pressure of the cutting edges and thus the associated probability of damage of the cutting edges is reduced.

It is further proposed that the counter blade is arranged in a contact surface on which the continuous web and the segment cut from the continuous web lie, and that a recess is provided in the contact surface on one side of the counter blade. Due to the recess in the contact surface, the cutting blade of the cutting rotating device, in particular the cutting drum, plunges at the side of the cutting edge of the counter blade into the recess and thus through the cutting plane into the continuous web or into the separating line between the end of the continuous web and the segment cut from it. Furthermore, an additional space is created by the recess in which the cut-off segment or the already cut portion of the continuous web can be received during the cutting process. Thus, the cut-off portion no longer interferes with the further cutting process. Furthermore, the cut-off segment can be received at least partially therein, such that it is better protected in this section from other external effects. Another advantage is that the cutting edges of the cut segment and the continuous web are separated from each other spatially and thus for example can be cleaned separately from each other.

Thus, preferably the recess has a base which has a greater length in the longitudinal direction of the contact surface than the section of the contact surface recessed by the recess. The proposed dimensions of the recess allow the cut-off segment to plunge into it without its free end coming into contact with the side surface of the counter blade. Therefore, the probability of damage of the cut-off segment can be reduced, and a gentler cut can be achieved. Furthermore, it can be avoided that the cut-off end is contaminated with cutting dust by possible contact with the counter blade.

Additionally, at least one compressed air opening which can be pressurised with negative pressure can be provided on one side of the counter blade, whereby the cut-off segment is sucked in and is held on one side of the counter blade until it is removed for further processing.

In this case, the compressed air opening can preferably be arranged in the recess such that the cut-off segment is sucked via the compressed air line onto a wall of the recess in particular onto the base surface of the recess, and thus is actively moved out of the cutting zone.

It is further proposed that the counter blade is arranged on a counter rotating body, in particular a counter drum, which is driven in an oppositely directed rotary movement in relation to the rotary movement of the cutting rotary device, in particular the cutting drum. Due to the proposed development, the cutting blade and the counter blade have a movement in the same direction of the movement of the fed continuous web when passing through the cutting plane. Since only the movement of the cutting edge of the cutting blade relative to the cutting edge of the counter blade is crucial for the cutting process, therefore the cutting speed can be reduced in the case of a simultaneously high transport speed of the continuous web, such that the cut quality can be improved in the case of a simultaneously high production rate.

Thus, the relative speed between the cutting edges can be easily achieved by the cutting rotating device, in particular the cutting drum, and the counter rotation body, in particular the counter drum, each being driven in rotary movement with different peripheral speeds of the cutting edges.

It is further proposed that the cutting rotating device, in particular the cutting drum, and the counter rotation body, in particular the counter drum, are each drivable by driving devices separated from each other. The advantage of this solution can be seen in that the driving movement of the cutting blade and the counter blade can be controlled such that they lie on each other over the entire cutting width during the cutting process with an identical force in the point-like contact. Therefore, the driving devices can be controlled in particular such that the cutting blades come to rest on the counter blades with a maximal force which is calculated so that the cutting blades and/or the counter blades do not break.

It is further proposed that in the region of the cutting blade of the cutting rotating device, in particular the cutting drum, and/or in the region of the counter blade, a suction device is provided. Due to the suction device, cutting particles which are released during the cutting of the segments, can be sucked in. On the basis of the arrangement of the suction device in the region of the cutting blade or of the counter blade, the cutting particles are sucked in directly at or as close as possible to their place of origin. Thus the air flow generated during the rotary movement of the cutting rotating device, in particular the cutting drum and, if the counter blade is arranged on a counter rotating body, in particular a counter drum, the air flow generated during the rotary movement of the counter rotation body, in particular the counter drum, can also be used to support the movement of the cutting particles towards the suction device.

It is further proposed that, a heating device is provided, by means of which the cutting blade and/or the counter blade can be heated at least in the region of their cutting edges. Due to the proposed heating device and the thereby resulting heating up of the cutting edges, the mechanical cutting effected by the point-like contact is supplemented by heat-cutting, which can achieve a clean cut. Thus, in particular breakouts and the formation of burrs are reduced and the segments are less damaged in general. Moreover, the emergence of cutting particles can be reduced. The heating device is thus designed such that the cutting edges are heated up to a temperature of approx. 600 degrees Celsius. Thus, the anode material, cathode material or separator material are slightly melted at least in the periphery of the plastic components, and this creates a smooth cutting edge. Furthermore, connected components of a layer of the segments are unable to break out. Furthermore, the displacement of the segments under the action of the cutting forces can be reduced by the heating up of the cutting edges, by the penetration of the cutting edges into the continuous web being assisted by the melting of the continuous web and reducing the mechanically cutting force to be applied.

The invention is explained in the following using preferred embodiments with reference to the appended figures. Here are shown:

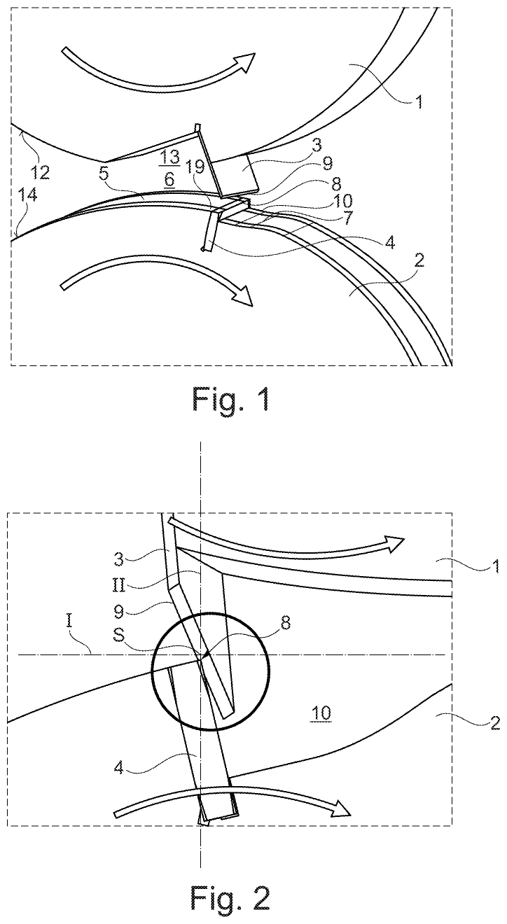

FIG. 1 a cutting apparatus according to the invention having a cutting rotating device in the form of a cutting drum and a counter rotation body in the form of a counter drum; and

FIG. 2 an enlarged section of the cutting apparatus with the cutting blade and the counter blade; and

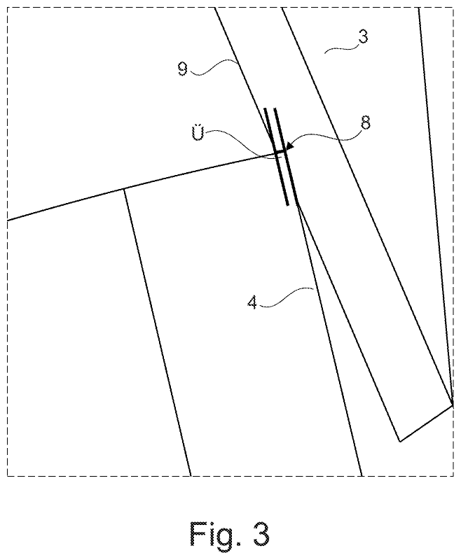

FIG. 3 the cutting edges of the cutting drum and the counter drum with an excess pressure in an enlarged representation; and

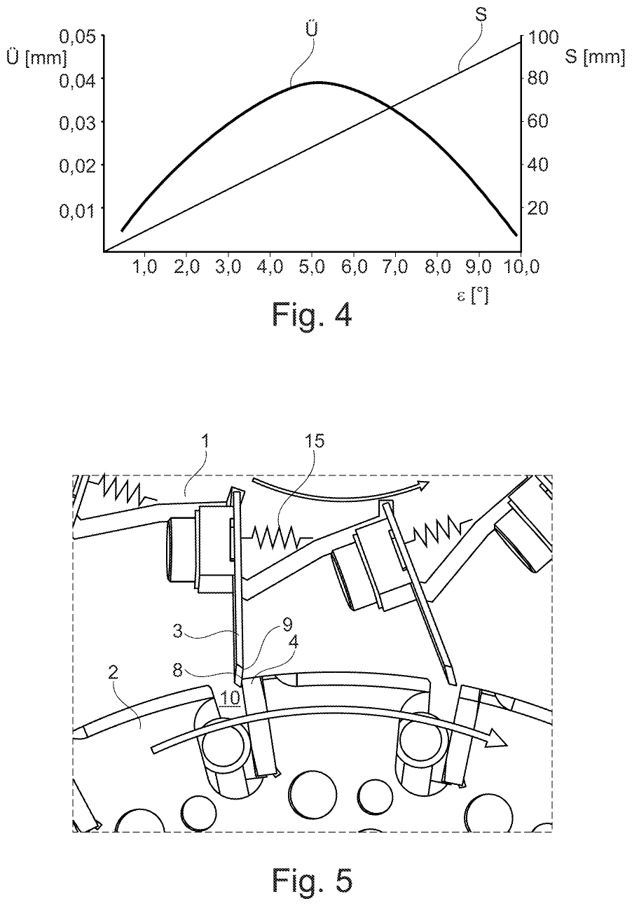

FIG. 4 an excess pressure of the cutting edges by the rotational angle of the counter drum; and

FIG. 5 a cutting drum, with a counter drum and resiliently mounted cutting blades; and

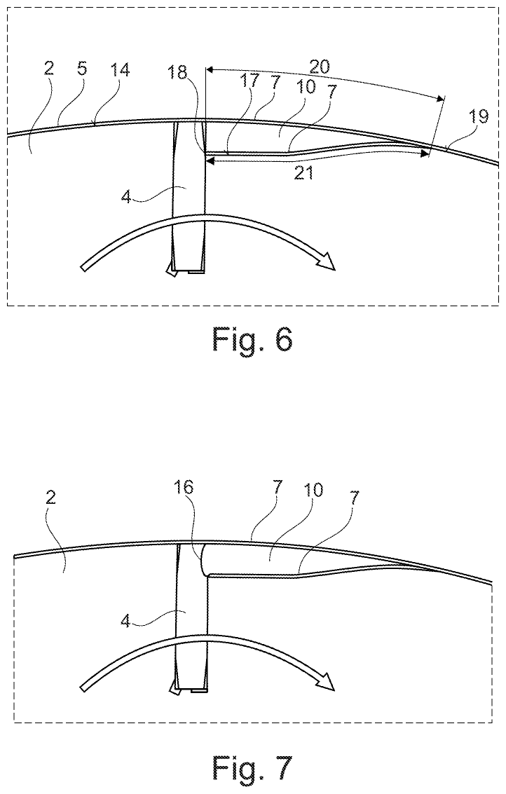

FIG. 6 an enlarged section of the counter drum with a recess; and

FIG. 7 an enlarged section of the counter drum with a recess and an undercut; and

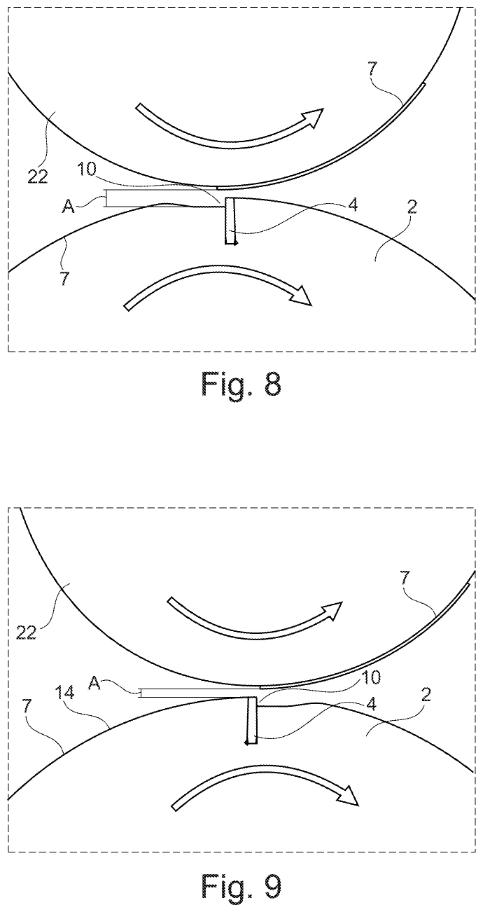

FIG. 8 a counter drum and a transfer drum according to a first exemplary embodiment; and

FIG. 9 a counter drum and a transfer drum according to a second exemplary embodiment; and

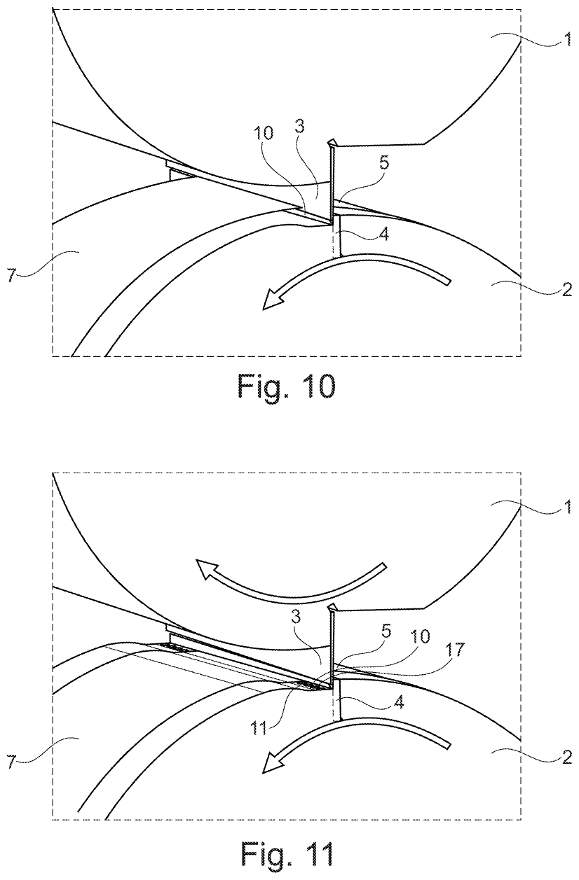

FIG. 10 a cutting drum with a counter drum with a recess; and

FIG. 11 a cutting drum with a counter drum with a recess and compressed air openings arranged therein; and

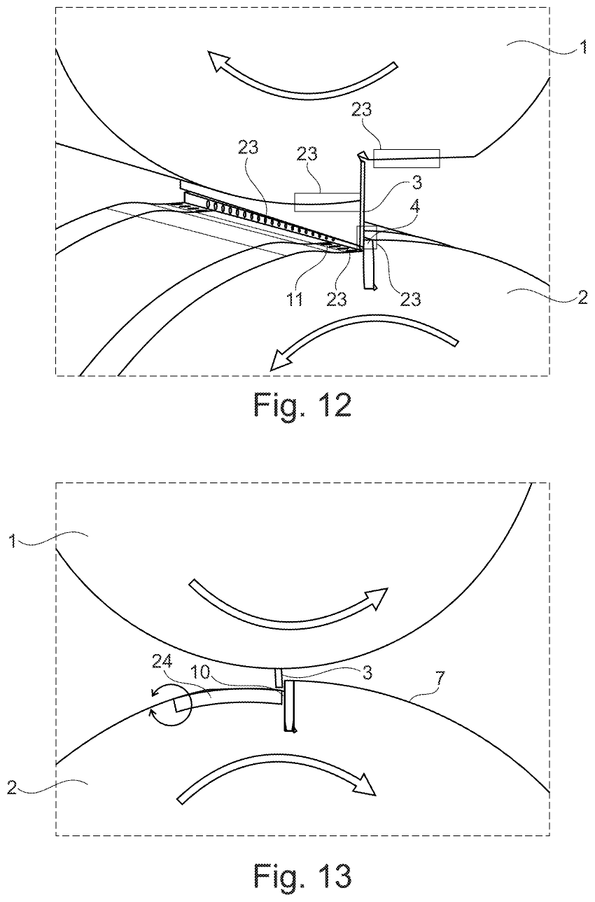

FIG. 12 a cutting drum with a counter drum with a recess and a suction device; and

FIG. 13 a cutting drum with a counter drum with a recess and a pivot element; and

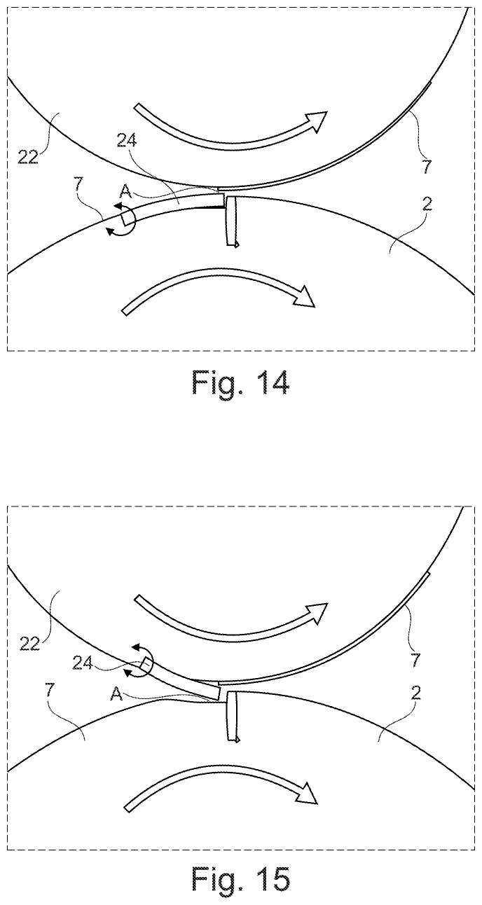

FIG. 14 a counter drum with a transfer drum and a pivot element in a first position; and

FIG. 15 a counter drum with a transfer drum and a pivot element in a second position; and

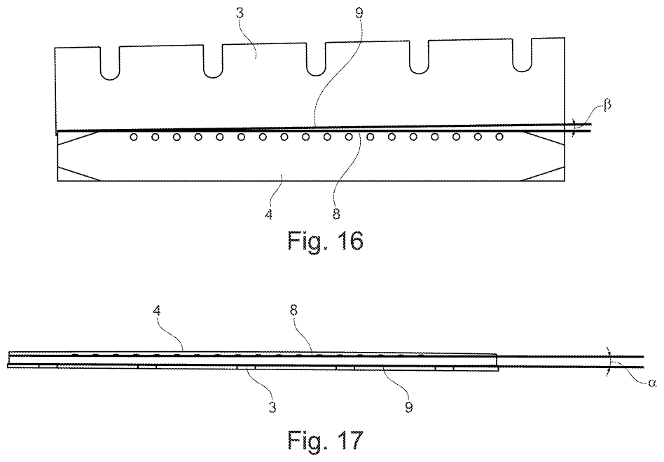

FIG. 16 an enlarged representation of the cutting blade of the cutting drum with the counter blade of the counter drum in the peripheral direction; and

FIG. 17 an enlarged representation of the cutting blade of the cutting drum with the counter blade of the counter drum perpendicular to the peripheral direction.

In FIGS. 1 and 2, a cutting apparatus according to the invention is to be recognised with a cutting rotating device in the shape of a cutting drum 1, driven in the direction of the arrow counterclockwise, and a counter rotating body in the shape of a counter drum 2, driven in the direction of the arrow clockwise. The cutting drum 1 and the counter drum 2 are arranged so that an intermediate space 6 is present between a lateral surface 12 of the cutting drum 1 and a lateral surface 14 of the counter drum 2, into which a continuous web 5 of a material to be cut is fed. The continuous web 5 can be formed by a web with a cathode or anode material or with a separator material for energy cells, such as is described in the description introduction.

Furthermore, the continuous web 5 can also be formed by a multi-layer composite web comprising a separator material and segments of an anode or cathode material laid on top, wherein the segments of the anode material or cathode material can be cut from a continuous web in a preceding step by an identical cutting apparatus.

The continuous web 5 rests against a contact surface 19 formed by the lateral surface 14 of the counter drum 2 and is fed into the intermediate space 6 by the rotary movement of the counter drum 2. Thus, the continuous web 5 can be held on the counter drum 2 by web tension alone or additionally or alternatively also by a vacuum device.

On the cutting drum 1 a radially projecting cutting blade 3 is arranged with a cutting edge 9, wherein a recess 13 in the lateral surface 12 of the cutting drum 1 is provided to form a one-sided free space on the cutting blade 3 upstream of the cutting blade 3 in relation to the rotary direction. The cutting blade 3, due to its radially projecting arrangement, has a free cutting edge 9 on its upstream side, whose interval to the base body of the cutting drum 1 is further enlarged by the recess 13.

On the counter drum 2 a counter blade 4 is provided which is arranged such that its radial outer surface is arranged on an identical radius to that of the lateral surface 14 and contact surface 19. Thus, the counter blade 4 with the lateral surface 14 and the contact surface 19 forms a continual, seamless outer surface, on which the continuous web 5 lies radially outwards. Furthermore, a recess 10 is provided in the contact surface 19 downstream to the counter blade 4 in relation to the rotary direction of the counter drum 2, such that the counter blade 4 has a free cutting edge 8 on its side arranged downstream. The counter blade 4 can be formed as a separate part independent from the counter drum 2, such that it can be exchanged after deterioration or breakage. The counter blade 4 can however likewise be formed as a single piece with the counter drum 2, by the counter drum 2 being shaped on its later surface 14 to the cutting edge 8. Thus, the cutting edge 8 can also be part of an insert portion of the counter drum which can already have the recess 10 and can also fulfil additional functions. In other words, the counter blade 4, along with the development of the cutting edge 8, can also have an additional shaping to fulfil additional functions.

In the described exemplary embodiment, a cutting blade 3 and a counter blade 4 are represented on the cutting drum 1 and on the counter drum 2, respectively, whereby it is not excluded that more cutting blades 3 and counter blades 4 are provided, arranged distributed on the periphery on the cutting drum 1 and on the counter drum 2. In contrast, it can even be useful to provide multiple cutting blades 3 and counter blades 4 arranged evenly distributed on the peripheries of the cutting drum 1 and the counter drum 2 if this enables more favourable cutting conditions to be achieved for cutting segments 7 with a predetermined length. If, for example, segments 7 of a length of 100 mm should be cut, the counter blades 4 are then arranged such that they divide the lateral surface 14 of the counter drum 2 into peripheral sections each with a curved length of 100 mm. Thus, the number of counter blades 4 is matched to the transport speed of the fed continuous web 5 and the rotational speed of the counter drum 2.

The cutting drum 1 and the counter drum 2 are driven in oppositely oriented rotary movements, such that they perform a movement in the same direction with their lateral surfaces 12 and 14 when passing through the intermediate space 6, which corresponds to the direction of the continuous web 5 fed onto the counter drum 2. The cutting drum 1 and the counter drum 2 are thus each driven in rotary movements with different peripheral speeds, such that the cutting blade 3 and the counter blade 4 perform a movement relative to each other when passing through the intermediate space 6. This is preferably achieved by the cutting drum 1 and the counter drum 2 being driven with identical rotational speeds, and the cutting circles of the revolving cutting edges 8 and 9 have different diameters. Thus, the cutting drum 1 with the cutting edges 9 of the cutting blade 3 has a greater cutting diameter than the cutting edges 8 of the counter blade 4 of the counter drum 2, such that the peripheral speed of the cutting edges 9 of the cutting blade 3 is greater than the peripheral speed of the cutting edges 8 of the counter blade 4. On the basis of the identical rotational speeds and the different diameters of the cutting circles, the cutting edges 8 and 9 meet each other once during a correspondingly synchronised movement in each revolution and thus perform the cutting movement of the continuous web 5 described in more detail in the following.

The cutting blade 3 is arranged on the cutting drum 1 so that the cutting edge 8 of the counter blade 4 comes into point-like contact S on the cutting edge 9 of the cutting blade 3 when it moves through the intermediate space 6. For this purpose, the cutting edge 9 of the cutting blade 3 of the cutting drum 1 is aligned at a first angle α of not equal to zero degrees, preferably at an angle α of 0 to 20 degrees in relation to the cutting edge 8 of the counter blade 4 in a cutting plane I running tangentially to the movement of the cutting edge 8 through the point-like contact S, as can also be seen in FIG. 17. Since the cutting edge 8 and 9 yield at least slightly owing to the resilient characteristics of the cutting blade 3 and/or of the counter blade 4, the cutting edges 8 and 9 do not lie in a mathematical point-like contact S on each other. The point-like contact S is instead marginally extended by the flexibility of the cutting edges 8 and 9.

Moreover, the cutting edge 9 of the cutting blade 3 is aligned to the cutting edge 8 of the counter blade 4 such that it extends at a second angle β not equal to zero degrees in a cutting plane II which extends through the point-like contact S and perpendicular to the movement of the cutting edge 8, thus perpendicular to the cutting plane I, as can also be seen in FIG. 16.

The cutting edge 8 of the counter blade 8 is parallel to the rotational axis of the counter drum 4 and perpendicular to the longitudinal direction of the continuous web 5 held on the counter drum 4 and thus also perpendicular to the peripheral movement of the lateral surface 14 of the counter drum 4 and the feeding movement of the continuous web 5.

Owing to the described inclination of the cutting edge 9 of the cutting blade 3 to the cutting edge 8 of the counter blade 4, the cutting blade 3 having the cutting edge 9 reaches a point-like contact surface on the cutting blade 8 of the counter blade 4 and severs the continuous web 5 lying thereon. Since the cutting edge 8 of the counter blade 4 of the counter drum 2 is moved with a smaller peripheral speed than the cutting edge 9 of the cutting blade 3 of the cutting drum 1, the point-like contact S of the cutting edge 9 of the cutting blade 3 slides on the cutting edge 8 of the counter blade 4 in the longitudinal direction of the cutting edge 8 of the counter blade 4 and severs the continuous web 8 in a cut line corresponding to the geometry of the cutting edge 8 of the counter blade 4. The counter blade 4 of the counter drum 2 is aligned perpendicular to the longitudinal direction of the continuous web 5, such that a segment 7 is cut from the continuous web 5 by the cut with a perpendicular cutting edge. The cut results, according to the shearing principle, in a continual cut transverse to the longitudinal extension of the continuous web 5, whereby a very clean and form-exact cutting edge of the segments 7 can be achieved.

Thus the inclination of the cutting edge 9 to the cutting edge 8 in the cutting plane I, in connection with the relative movement of the cutting edges 8 and 9 to each other realised by the different peripheral speeds, effects the sideways sliding of the cutting edge 9 of the cutting blade 3 in the point-like contact S on the cutting edge 8 of the counter blade 4. Due to the inclination of the cutting edge 9 in the cutting plane II, the sliding is enabled further by a compensation of the distance reduction of the cutting edge 8 to the cutting drum 1 caused by the circular movement of the cutting edge 8 of the cutting blade 4. Thus, the recess 10 provided downstream of the counter blade 4 enables the cutting blade 3 of the cutting drum 1 to be plunged radially inwards through the notional extension of the lateral surface 14 of the counter drum 2 during the cutting movement downstream of the counter blade 4. This results in a perpendicular cut through the continuous web 5, which is realised by a cutting point S running on a curved cutting line in space, wherein the cutting line is realised by a combination of a movement transverse to the continuous web 5 and a movement on a circular arc section. The circular arc section of the cutting movement corresponds to the angle of rotation of the counter drum 2 starting from the first cutting contact of the continuous web 5 up to the complete cut of the continuous web 5. By plunging the cut end of the segment 7, the cut edges of the cut segment 7 and the end of the continuous web 5 still in contact with the counter blade 2 are spatially separated from each other, making it possible to clean the cut surfaces more precisely by means of suction. In addition, cutting dust adhering to the counter blade 4 is not wiped off at the material edge of the segment 7, and the blades of the cutting blades 3 and the counter blades 4 can be cleaned at a maximum distance, preferably at a position of the counter drum 2 and the cutting drum 3 rotated by 180 degrees, without contaminating the continuous web 5.

As the two cutting edges 8 and 9 lie against each other in the point-like contact S during the cutting movement, part of the continuous web 5 is still connected across the cutting line until the cut is complete. Furthermore, after the cut, the free end of the continuous web 5 is in contact with the outer side of the counter blade 4, which merges seamlessly into the lateral surface 14 of the counter drum 2. This free end of the continuous web 5 then forms the second end of the following cut segment 7. The cut of the segments 7 is realised here with a cutting edge 8 of the counter blade 4 directed perpendicular to the continuous web 5 and parallel to the rotational axis of the counter drum 2, which is advantageous in that, firstly, a perpendicular cut through the continuous web 5 can be realised and, secondly, the continuous web 5 lying against the lateral surface 14 is not rotated around its longitudinal axis. It is also conceivable, however, to arrange the cutting edge 8 of the counter blade 4 at an angle to the rotational axis of the counter drum 2 in relation to a plane that is tangential to or perpendicularly intersects the lateral surface 14, insofar as the cut requires this, or the cut will thereby be improved further.

In FIG. 17, the shape of the cutting edges 8 and 9 can be seen in a cut along the cutting plane I in as seen from above. The cutting edges 8 and 9 are aligned at first angle α of approx. 2 to 5 degrees and come into point-like contact S with each other during the following revolution movement. In FIG. 16, the second angle β is evident which here is likewise approx. 2 to 5 degrees. The cutting edges 8 and 9 initially come into point-like contact S with each other on one side. During the further revolution movement of the cutting drum 1 and the counter drum 4, the cutting edge 9 of the cutting blade 3 slides on the cutting edge 8 of the counter blade 4 and thereby performs the cutting movement of the continuous web 5, wherein the changing distance of the cutting edges 8 and 9 is compensated by the second angle β.

The rotary movements of cutting drum 1 and counter drum 2 are coordinated with each other such that both the cutting edges 8 and 9 come into contact with each other in the point-like contact S during the revolution according to the above-described course and cut the continuous web 5. The cutting process requires a contact, as otherwise the shearing movement can be interrupted or not cleanly executed, whereby the cut quality of the segments 7 would be reduced. So that this contact is not lost, the movement of the cutting drum 1 and the counter drum 2 is designed in connection with the alignment and arrangement of the cutting edge 8 and 9 such that the cutting blade 3 comes to rest on the cutting edge 8 of the counter blade 4 with an excess pressure Ü, as is evident in FIG. 3. The cutting blade 3 thereby exerts pressure onto the counter blade 4 and vice versa. The excess pressure Ü does not naturally lead to the counter blade 4 penetrating with its cutting edge 8 into the cutting edge 9 of the cutting blade 3, as is shown in FIG. 3. The illustration is only intended to make the principle of excess pressure Ü clearer. Instead, the cutting blade 3 and/or the counter blade 4 is pushed away slightly, utilising its resilient properties, whereby the point-like contact S is also slightly elongated. FIG. 4 shows a curve of the excess pressure U over the angle of rotation & of the counter drum 4 for a cutting width s of the continuous web of 100 mm. The excess pressure Ü relative to the cutting width of the continuous web 5 can also be seen. The angle of rotation ε=0 degrees in the diagrams corresponds to the start of the cutting movement. At the beginning of the cutting movement, the excess pressure U rises in a convex curve to a maximum and then falls steeply again.

The excess pressure Ü leads to an elastic movement of the cutting blade 3 and the counter blade 4 and, in extreme cases, can lead to blade breakage or damage to one of the cutting edges 8 or 9 if the plastic deformation limit is exceeded locally. To counteract this effect, the cutting edges 8 and 9 or even just one of the cutting edges 8 or 9 can be slightly concave, i.e., curved inwards, whereby the concave shape ideally corresponds to the negative shape of the measured convex excess pressure U. This concave shape of the cutting edges 8 or 9 allows the maximum excess pressure Ü to be reduced and, in ideal cases, equalised without the contact between cutting edges 8 and 9 being lost during the cutting process. As a result, the forces acting on the cutting edges 8 and 9 can be reduced and thus the probability of damage to the cutting blade 3 and the counter blade 4 can be reduced. Furthermore, the breakage of the cutting blades 3 and the counter blades 4 or their cutting edges 8 and 9 can also be avoided by using a resilient material for the cutting blades 3 and counter blades 4, so that these can yield at least slightly.

FIG. 5 shows an embodiment of the invention in which a recess 10 is arranged on each of the counter blades 4 upstream of the rotary movement of the counter drum 2, so that the free cutting edge 8 of the counter blade 4 is arranged on the upstream side of the counter blade 4. The cutting blades 3 of the cutting drum 1 are arranged here so that their free cutting edges 9 are arranged downstream of the direction of rotation of the cutting drum 1. The cutting process takes place here in that the cutting drum 1 with the cutting blades 3 and the cutting edges 9 arranged thereon is driven at a higher peripheral speed than the counter blades 4 of the counter drum 2, so that the cutting blade 3 slides with its cutting edge 9 on the cutting edge 8 of the respective counter blade 4 and cuts the continuous web 5 according to the principle described above.

Furthermore, the cutting blades 3 of the cutting drum 1 are resiliently mounted by springs 15, so that the cutting forces acting between the cutting edges 8 and 9 are reduced by allowing the cutting blades 3 to perform an evasive movement. This means that stiffer cutting blades 3 can be used without increasing the probability of damage in the form of blade breakage. The resilient mounting of the cutting blades 3 can reduce the excess pressure Ü of the cutting edges 8 and 9 described above without them losing their contact. Rather, the spring force provided by the springs 15 and their arrangement provide further design parameters for influencing the cutting process. If the cutting drum 3 and the counter drum 4 are driven independently of each other by different drive devices, it is also possible to control the drive movement of the cutting drum 3 and the counter drum 4 depending on the cutting forces acting on them, depending on the acting cutting forces. This prevents a predetermined cutting force from being exceeded and possible blade breakage as a result. The different peripheral speeds of cutting edges 8 and 9 are realised here with identical rotational speeds and different cutting circle diameters of the cutting edges 8 and 9. If the cutting drum 1 and the counter drum 2 are driven by different drive devices, i.e. by individual drives, it would also be conceivable to control the rotational speed of the cutting drum 1 and the counter drum 2 differently and individually and thus additionally control or bring about the relative speeds of the cutting edges 8 and 9 during the cutting process. In particular, the excess pressure Ü of the cutting edges 8 and 9 can thus be controlled in such a way that the load on the cutting edges 8 and 9 is reduced and possible blade breakage is avoided.

FIG. 6 shows an enlarged section of the counter drum 2 and the counter blade 4 of the exemplary embodiment shown in FIGS. 1 and 2. The recess 10 in the contact surface 19 is shaped in such a way that its base surface 17 has a greater length 21 in the circumferential direction of the counter drum 2 than the section 20 of the contact surface 19 that is radially interrupted on the outside by the recess 10. This allows the segment 7 cut from the continuous web 5 to plunge into the recess 10 from the upper position shown, without its free end side 18 touching or rubbing against the side surface of the counter blade 4. This reduces the likelihood of damage to segment 7 and enables the segments 7 to be cut gently. This can also prevent contamination of the cut segment with cutting particles.

In FIG. 7, an additional undercut 16 is provided on the counter blade 4, extending the recess 10 into the counter blade 4, by means of which undercut the free space between the free end side 18 of the cut-off segment 7 and the side surface of the counter blade 4 can be further enlarged to prevent contact of the segment 7 with the counter blade 4 when plunging into the recess 10.

FIGS. 8 and 9 each show the counter drum 2 in two different embodiments with a receiving drum 22 with a segment 7 on the counter drum 2 and a segment 7 received by the receiving drum 22. In the exemplary embodiment shown in FIG. 8, the recess 10 is positioned in relation to the rotary movement of the counter drum 2 upstream of the counter blade 4 in accordance with the exemplary embodiment shown in FIG. 5, so that there is an increased distance A upstream of the counter blade 4 to the receiving drum 22 for the reception of the segments 7 from the receiving drum.

In FIG. 9, the recess 10 is positioned in relation to the rotary movement of the counter drum 2 downstream of the counter blade 4 in accordance with the exemplary embodiment shown in FIGS. 1 and 2. As already described above, the ends of the segments 7 are in contact with the outer surface of the counter blade 4 of the counter drum 2 due to the previous cut of the continuous web 5 and are taken over by the receiving drum 22 starting from this end. This arrangement results in a much smaller distance A to be overcome between the outer surface of the counter blade 4, against which the end of the segment 7 rests, and the receiving drum 22 for the transfer of the segments 7, whereby the transfer of the segments 7 itself can be made more process-reliable and easier. Due to this smaller distance A, the predetermined placement position of the segments 7 on the receiving drum 22 can be maintained more reproducibly and more accurately.

As can be seen in FIG. 10, the cut of the continuous web 5 between the cutting blade 3 and the counter blade 4 causes the continuous web 5 to be severed first on one side, in this case the front side, and thus to hang freely in the air for a short time with the already cut section. As a result, there is a risk that the cutting blade 3 of the cutting drum 1 or the cutting blade 4 of the counter drum 2 will collide uncontrollably with this free-hanging section and thus damage it. To avoid this disadvantage, according to the exemplary embodiment of FIG. 11, several 11 that can be pressurised with negative pressure are provided in the base surface 17 of the recess 10, which compressed air openings suck in the already cut section of the continuous web 5 or the segment 7 for contact with the base surface 17 and thus actively move it away from the cutting zone. This prevents the cut-off section of the segment 7 from coming into contact with the cutting blade 3 of the cutting drum 1, which plunges into the recess 10. The compressed air openings 11 can all be pressurised simultaneously. However, it is also conceivable to pressurise the compressed air openings 11 with negative pressure in a timed sequence. For example, the compressed air openings 11 can be pressurised with negative pressure in such a way that the compressed air openings 11 are pressurised in accordance with the cutting process of the continuous web 5 by first pressurising the compressed air opening 11, which is located at the edge of the continuous web 5 that was cut first, and then pressurising the other compressed air openings 11 with compressed air in a staggered manner in a successive sequence. The compressed air openings 11 are thus pressurised with compressed air one after the other, starting from one edge and following the laterally moving cutting point S, so that only the section of the continuous web 5 or segment 7 that has already been cut off is pressurised and sucked onto the base surface 17 of the recess 10. This prevents the continuous web 5 from being torn in an uncontrolled manner by the application of negative pressure before it is cut.

As can be seen in FIG. 12, an additional suction device 23 can be provided, which sucks up the cutting dust produced by cutting the continuous web 5. The compressed air openings 11 provided in the recess 10 can also be used to suck up the cutting dust. The suction device 23 can comprise several or individual suction openings provided at the marked points, which can also be positioned in such a way that the air flows generated by the rotary movements of the cutting drum 1 and the counter drum 2 assist the transport of the cutting dust to the suction openings. The suction devices 23 are moved along with the cutting drum 1 or the counter drum 2 and are then connected to a stationary suction device 23 at an intersection. It is also conceivable to provide exclusively a stationary suction device 23, which is then directed in such a way that it sucks up the cutting dust produced locally from a defined cutting point of the cutting device, whereby the rotary movements of the cutting drum 1 and the counter drum 2 can again have an additional effect for conveying the cutting dust to the suction device 23.

FIG. 13 shows a further developed exemplary embodiment in which a pivot element 24 is additionally provided in the recess 10. The pivot element 24 is pivotally mounted at its end further away from the counter blade 4 so that it can pivot about a pivot axis aligned parallel to the rotational axis of the counter drum 2 and projects with its free pivotable end into the recess 10. The pivot element 24 is pivoted into the recess 10 during the cutting process, so that the cut edges are separated with the advantages described above and the cutting process can take place according to the sequence described above. The pivot element 24 is then only pivoted radially outwards with its free end about a pivot axis parallel to the rotational axis of the counter drum 2 when the counter drum 2 continues to revolve until the transfer position shown in FIG. 14 is reached. As a result, the distance A to be overcome for receiving the segments 7 from the receiving drum 22 can be reduced with the advantages described above. The same advantage can also be achieved by a pivot element 24 provided on the receiving drum 22, as can be seen in FIG. 15.

The cutting edges 8 and 9 of the cutting blade 3 and the counter blade 4 can be heated to a temperature of approx. 600 degrees Celsius by a separate or also a central heating device, whereby the cutting quality can be further improved. However, it is also conceivable to heat the cutting edges 8 and 9 to a lower temperature, depending on the material of the segments 7 to be cut if this is necessary or sufficient for the cut. In any case, an improved thermomechanical cutting of the segments 7 can be realised by a combination of mechanical cutting as a result of the above-described sliding of the cutting edges 8 and 9 in conjunction with the heating of the cutting edges.

1. A cutting apparatus for cutting segments for energy cells from a continuous web fed into an intermediate space in a cutting plane comprising:
a cutting rotating device which is driven in rotary movement around a rotational axis by means of a driving device, is arranged on one side of the intermediate space and has at least one cutting blade projecting radially outwards from an interface of the cutting rotating device; and
at least one counter blade arranged on the other side of the intermediate space, wherein
the cutting blade and the counter blade each have a cutting edge, wherein
the cutting edge of the cutting blade comes into point-like contact with the cutting edge of the counter blade during the rotary movement of the cutting rotating device and is thereby aligned at an angle not equal to zero degrees to the cutting edge of the counter blade, and wherein
the cutting edge of the cutting blade slides on the cutting edge of the counter blade during the rotary movement of the cutting rotating device, in particular the cutting drum, with a cut being made in the continuous web during the point-like contact.

2. The cutting apparatus according to claim 1, wherein
the angle is at most 20 degrees.

3. The cutting apparatus according to claim 1, wherein
the cutting edges are aligned in relation to each other in a cutting plane running through the point-like contact at a first angle (α) not equal to zero degrees.

4. The cutting apparatus according to claim 1, wherein
the cutting edges are aligned in relation to each other perpendicular to the cutting plane at a second angle (β) not equal to zero degrees.

5. The cutting apparatus according to claim 1, wherein
the cutting blade and/or counter blade are resiliently mounted.

6. The cutting apparatus according to claim 1, wherein
the cutting edge of the cutting blade and/or the cutting edge of the counter blade has a concave shape.

7. The cutting apparatus according to claim 1, wherein
the counter blade is arranged in a contact surface on which the continuous web and the segment cut from the continuous web lie, and in that a recess is provided in the contact surface on one side of the counter blade.

8. The cutting apparatus according to claim 7, wherein
the recess has a base which has a greater length in the longitudinal direction of the contact surface than the section of the contact surface recessed by the recess.

9. The cutting apparatus according to claim 1, wherein
on one side of the counter blade, at least one compressed air opening is provided which can be pressurised with negative pressure.

10. The cutting apparatus according to claim 7, wherein
the compressed air opening is arranged in the recess.

11. The cutting apparatus according to claim 10, wherein
in the recess a plurality of compressed air openings are arranged in a row parallel to the cutting edge of the counter blade.

12. The cutting apparatus according to claim 11, wherein
the compressed air openings are pressurised with negative pressure with a time delay in a sequence following the point-like contact.

13. The cutting apparatus according to claim 1, wherein
the counter blade is arranged on a counter rotating body which is driven in an oppositely directed rotary movement in relation to the rotary movement of the cutting rotating device.

14. The cutting apparatus according to claim 13, wherein
the cutting rotating device and the counter rotation body are each driven in rotary movement with different peripheral speeds of the cutting edges.

15. The cutting apparatus according to claim 13, wherein
the cutting rotating device and the counter rotation body are each drivable by driving devices separated from each other.

16. The cutting apparatus according to claim 1, wherein
in the region of the cutting blade of the cutting rotating device, in particular of the cutting drum, and/or in the region of the counter blade, a suction device is provided.

17. The cutting apparatus according to claim 1, wherein
a heating device is provided, by means of which the cutting blade and/or the counter blade can be heated at least in the region of their cutting edges.

18. The cutting apparatus according to claim 9, wherein
the compressed air opening is arranged in the recess.

19. The cutting apparatus according to claim 18, wherein
in the recess a plurality of compressed air openings are arranged in a row parallel to the cutting edge of the counter blade.

20. The cutting apparatus according to claim 19, wherein
the compressed air openings are pressurised with negative pressure with a time delay in a sequence following the point-like contact.
